(19) United States
(12) Patent Application Publication
(10) Pub. No.: US 2014/0100940 A1
(43) Pub. Date: Apr. 10, 2014

(54) REBATE MARKETING PROMOTIONS ASSISTANT

(71) Applicants: Matthew D. Gerrior, Troy, NY (US); Joseph W. Payette, Troy, NY (US); Annmarie Lanesey Payette, Troy, NY (US)

(72) Inventors: Joseph W. Payette, Troy, NY (US); Annmarie Lanesey Payette, Troy, NY (US); Matthew D. Gerrior, Watervliet, NY (US)

(21) Appl. No.: 14/022,441

(22) Filed: Sep. 10, 2013

Related U.S. Application Data
(60) Provisional application No. 61/698,865, filed on Sep. 10, 2012.

(51) Int. Cl. G06Q 30/02

(52) U.S. Cl. CPC G06Q 30/0234
USPC 705/14.34

(57) ABSTRACT

According to one embodiment, a system and methods that provides computer-aided discovery, collection, storage, organization, tracking, monitoring, notification, integration, presentation, analysis, and augmentation or otherwise processing of Rebate Marketing Promotion information. Additionally, the system and methods provides a means for computers to communicate over a network with other computers to process Rebate Marketing Promotion information, by means of discovery, collection, organization, storing, augmenting, presentation of promotion information stored in a database, presentation of the promotional information to consumers, organizations, and third-parties, allow tracking, notification, and monitoring of promotional information to alert consumers, organizations, and third-parties to changes of the database, analysis of the database to provide additional information about or relating to usage of the database.

As a result, Rebate Marketing Promotion Assistant substantially assists consumers, organizations, and third-parties in Rebate Marketing Promotion utilization, which capitalizes on Rebate Marketing Promotion information intelligence.

### CROSS-REFERENCE TO RELATED APPLICATIONS

This application claims benefit of co-pending U.S. Provisional Application No. 61/698,865, filed Sep. 10, 2012, which is hereby incorporated herein

### FEDERALLY SPONSORED RESEARCH

None

### SEQUENCE LISTING

None

### BACKGROUND

Merchants, retailers, and manufacturers often engage in marketing efforts to promote their products and services. One of these marketing efforts are to offer consumers, organizations, and third-parties discounted products and services allowing them to stay competitive and increase sales revenues. The process of these marketing efforts are called Rebate Marketing Promotions.

Consumers, organizations, and third-parties learn about Rebate Marketing Promotions through widespread communication networks, channels, and devices. Additionally, each merchant, retailer, and manufacturer has structured and communicated their Rebate Marketing Promotions in different ways to gain competitive advantages.

Considering the above, there previously wasn't an easy and efficient way to collect, store, organize, track, monitor, alert, analyze, redeem, verify and validate, augment, and process Rebate Marketing Promotions from one or more merchants, retailers, and manufacturers, using one or more networks, channels, and devices, following different promotional structures and protocols. For example, if a consumer or business wanted to take advantage of a Rebate Marketing Promotion they would have to, subject to the requirements and protocols of the Rebate Marketing Promotion:
1. Learn about the promotional program and research additional information not directly provided by the promotion
2. Collect necessary documentation, proof, or evidence required by the promotion
3. Make necessary copies of the collected documentation and store copies of the documentation for later reference
4. Submit original documentation with additional information collected by the research effort
5. Set alerts (or reminders) for long submittal responses, if promotional documentation contains expected response information
6. Track, monitor, analyze the status of the submittal
7. Analyze, verify, and validate the submittal response according to the promotional and stored documentation.

The prior example is multiplied in complexity if a consumer or business wanted to take advantage of more than one Rebate Marketing Promotion from different retailers, merchants, and manufacturers. Also, missing a step or requirement of a Rebate Marketing Promotion could result in immediate rejection of a submittal. For example, if
1. Requirements or protocols of a promotion are difficult and time consuming to understand or follow
2. Additional information required is difficult to research and hard to find
3. Necessary documentation, proof, or evidence is accidentally forgotten during the submittal
4. Not all copies of documentation were made for later reference
5. Alerts (or reminders) were not given in the promotion or they were difficult to understand
6. Tracking and monitoring is manual and not provided by the promotion
7. Verification of validation of submittal response is difficult to understand or the response isn't communicated effectively
8. No information is given about overall participation in more than one promotion of a consumer or business

### Advantages

Accordingly, several advantages of one or more aspects are as follows: discovery of Rebate Marketing Promotions from one or more sources; organization and augmentation of collected Rebate Marketing Promotions contained within a database; storage and presentation of organized and augmented Rebate Marketing Promotions within the database; tracking, monitoring, and registration of notifications and alerts to changes of the database; analysis of the database to provide additional information about or relating to Rebate Marketing Promotions; integration of the database and redemption protocols for verification and validation of Rebate Marketing Promotions submittal results.

Other advantages of one or more aspects will be apparent from a consideration of the drawings and ensuing description.

### SUMMARY

In accordance with one embodiment, a system and methods that aid consumers, organizations, and third parties in utilizing Rebate Marketing Promotions information.

### DRAWINGS FIGURES

FIG. 1 shows a system for processing Rebate Marketing Promotion information.

FIGS. 2A and 2B shows an authoritative system for providing, consuming, storing, and processing Rebate Marketing Promotion information.

FIG. 3 shows a system for consuming Rebate Marketing Promotions.

FIG. 4 shows a system for providing Rebate Marketing Promotions.

FIG. 5 shows a table for storing Rebate Marketing Promotions.

FIG. 6 shows a table for storing consumers, organizations, and third-parties.

FIG. 7 shows a table for storing Rebate Marketing Promotions Retailers.

FIG. 8 shows a table for storing Rebate Marketing Promotions Categories.

FIG. 9 shows a table for storing Rebate Marketing Promotions Manufacturers.

FIG. 10 shows a table for storing Rebate Marketing Promotions Brands.

FIG. 11 shows a table for storing Tracked Rebate Marketing Promotions for consumers, organizations, and third-parties.

FIG. 12 shows a table for Tracked Manufacturers, Brands, and Categories for consumers, organizations, and third-parties.

FIG. 13 shows a table for storing Consumer and Business System Activities.

FIG. 14 shows a flowchart of a method that discovers, reconciles, and publishes Rebate Marketing Promotions.

FIG. 15 shows a flowchart of a method that scans for new or updated Rebate Marketing Promotions and organizes them for future processing.

FIG. 16 shows a flowchart of a method that exports a scanned Rebate Marketing Promotions Package to reconcile and import for future processing.

FIG. 17 shows a flowchart of a method that archives similar and publishes Rebate Marketing Promotions.

FIG. 18 show a flowchart of a method that processes a collection of Regular Rebate Marketing Promotions lifecycle events.

FIG. 19 shows a flowchart of a method that tracks, monitors, and notifies consumers, organizations, and third-parties of Regular Rebate Marketing Promotions life cycle events.

FIG. 20 show a flowchart of a method that processes a collection of Reward Rebate Marketing Promotions lifecycle events.

FIG. 21 shows a flowchart of a method that tracks, monitors, and notifies consumers, organizations, and third-parties of Reward Rebate Marketing Promotions lifecycle events.

FIG. 22 shows a flowchart of a method that stores Rebate Marketing Promotion interests by consumers, organizations, and third-parties.

### DETAILED DESCRIPTION

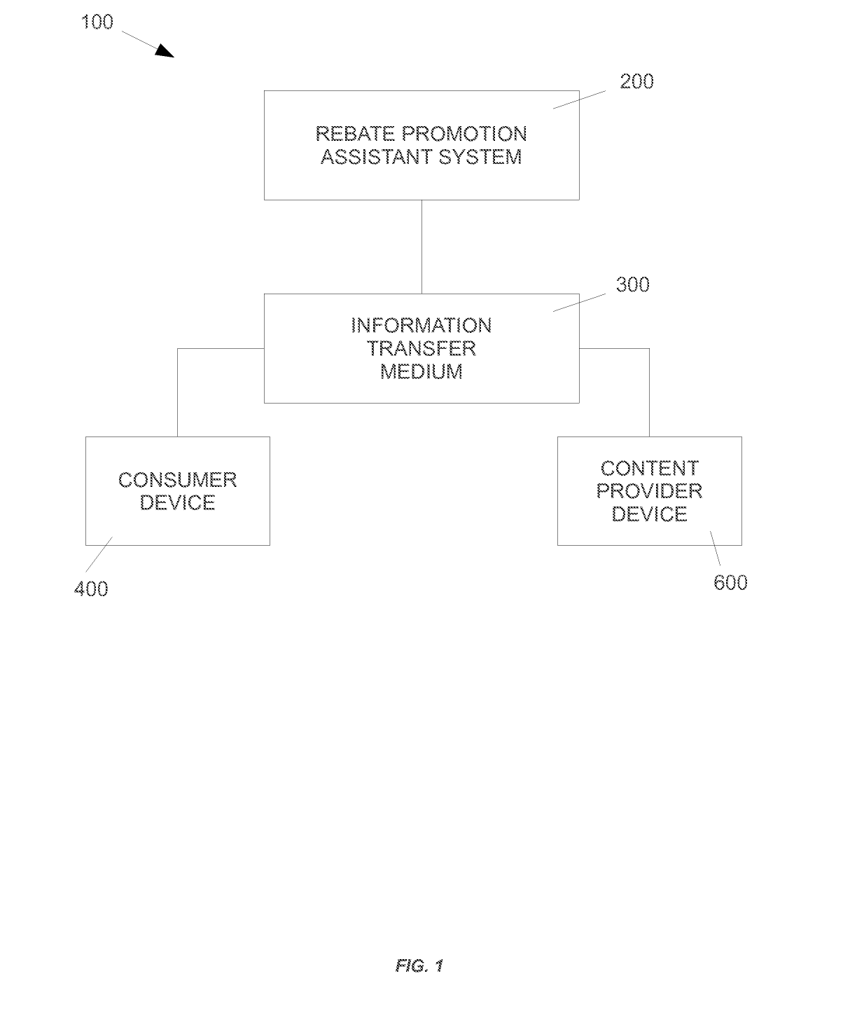

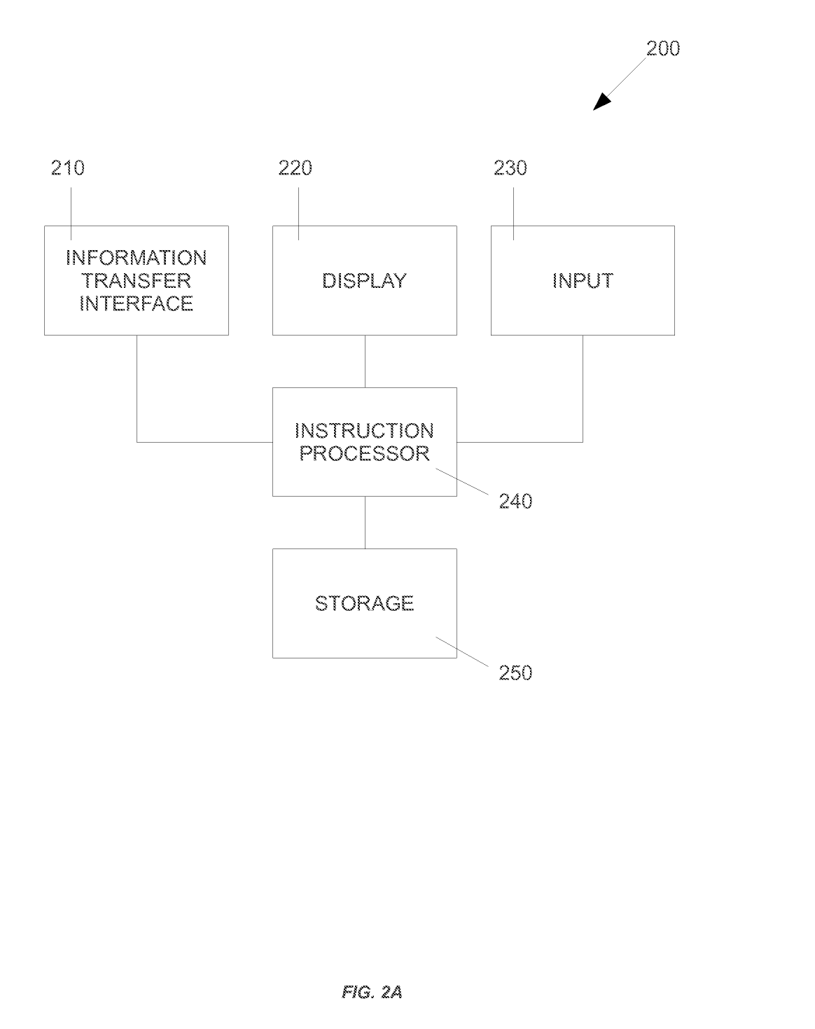

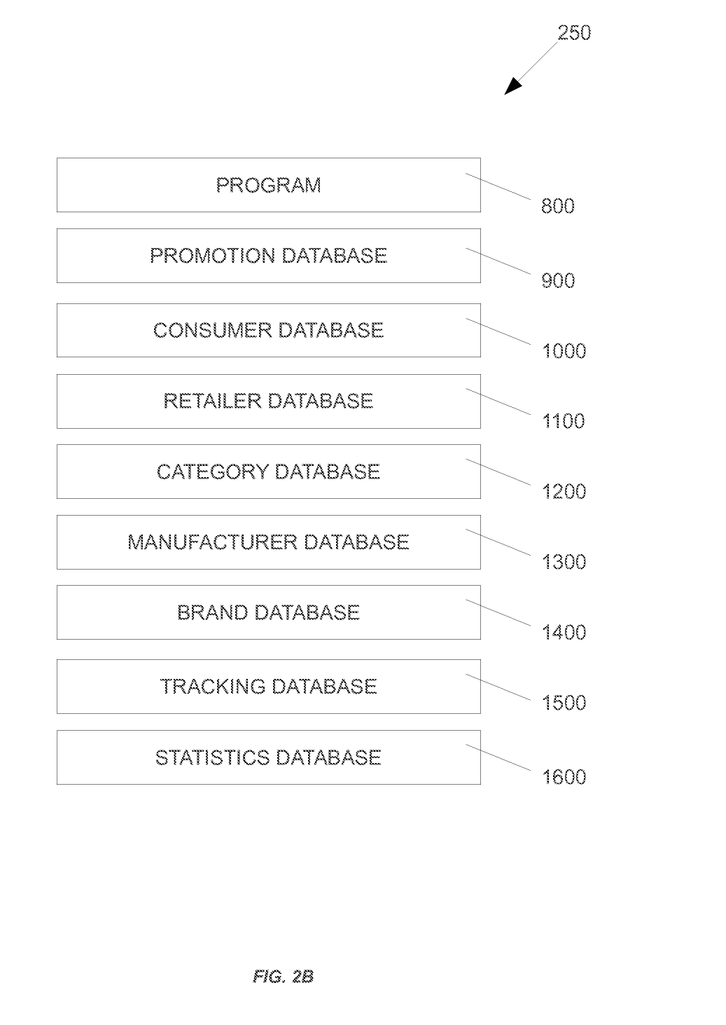

One embodiment of the Rebate Marketing Promotions Assistant (“Assistant System”) 100 is illustrated in FIG. 1. The Assistant System 200 is connected to an Information Transfer Medium 300 that can send and retrieve information to and from Consumer Devices 400 and Content Provider Devices 600. The Assistant System 200 is comprised of an Information Transfer Interface 210, Display 220, Input peripheral 230, Program 800 Instruction Processor 240, and Storage 250 devices, illustrated in FIGS. 2A and 2B. The Assistant System 200 Information Transfer Interface 210 can send and receive Rebate Marketing Promotion information to and from Consumer Devices 400 and Content Provider Devices 600. The Assistant System 200 Display 220 and Input peripheral 230 devices allow an operator to control the configuration of Assistant System 200. The Assistant System 200 instruction Processor 240 executes Assistant System 200 Program 800 instructions stored in Storage 250 device, Assistant System 200 stores Program 800, Promotion Database 900, Consumer Database 1000, Retailer Database 1100, Category Database 1200, Manufacturer Database 1300, Brand Database 1400, Tracking Database 1500, and Statistics Database 1600 in Assistant System 200 Storage 250 device.

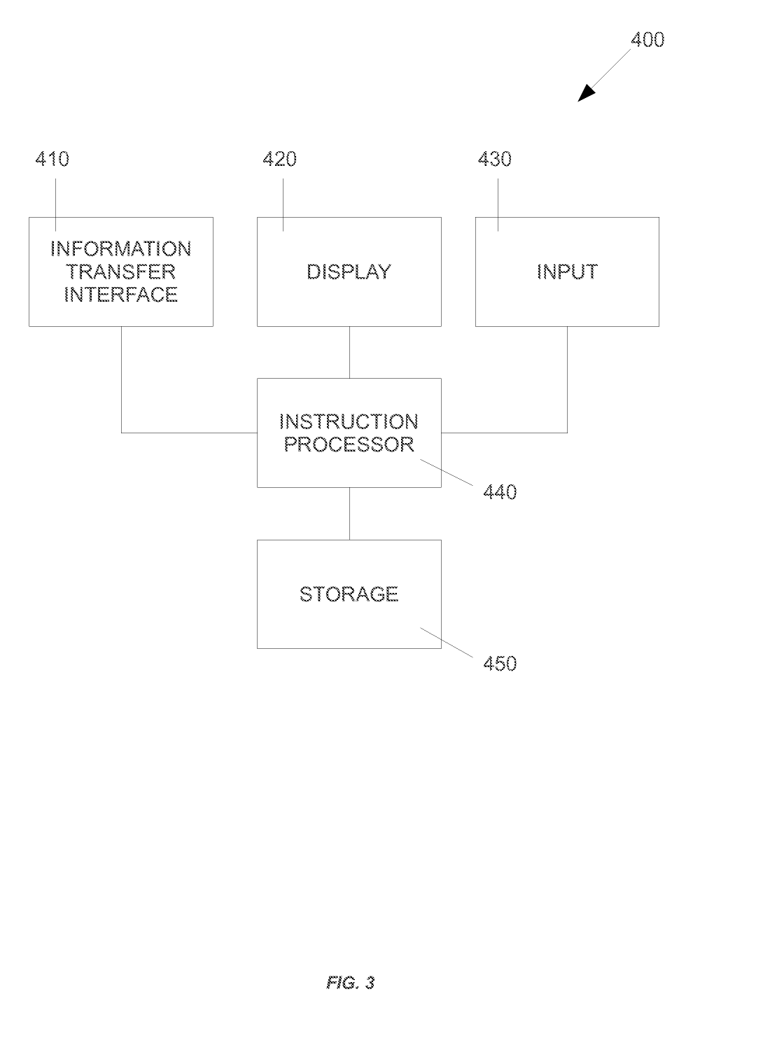

FIG. 3 illustrates a Consumer Device 400 comprised of an Information Transfer Interface 410, Display 420, input peripheral 430, Instruction Processor 440, and Storage 450 device. Consumer Devices 400 are connected to an Information Transfer Medium 300 that can send and receive Rebate Marketing Promotion information to the Assistant System 200, Consumer Devices 400 have Display 420, Input peripheral 430, and instruction Processor 440 devices that allow Consumers to view Rebate Marketing Promotion information and interact with Assistant System 200. Consumer Devices 400 store identifying information on Storage 450 device used by the Assistant System 200 to identify an individual Consumer Devices 400.

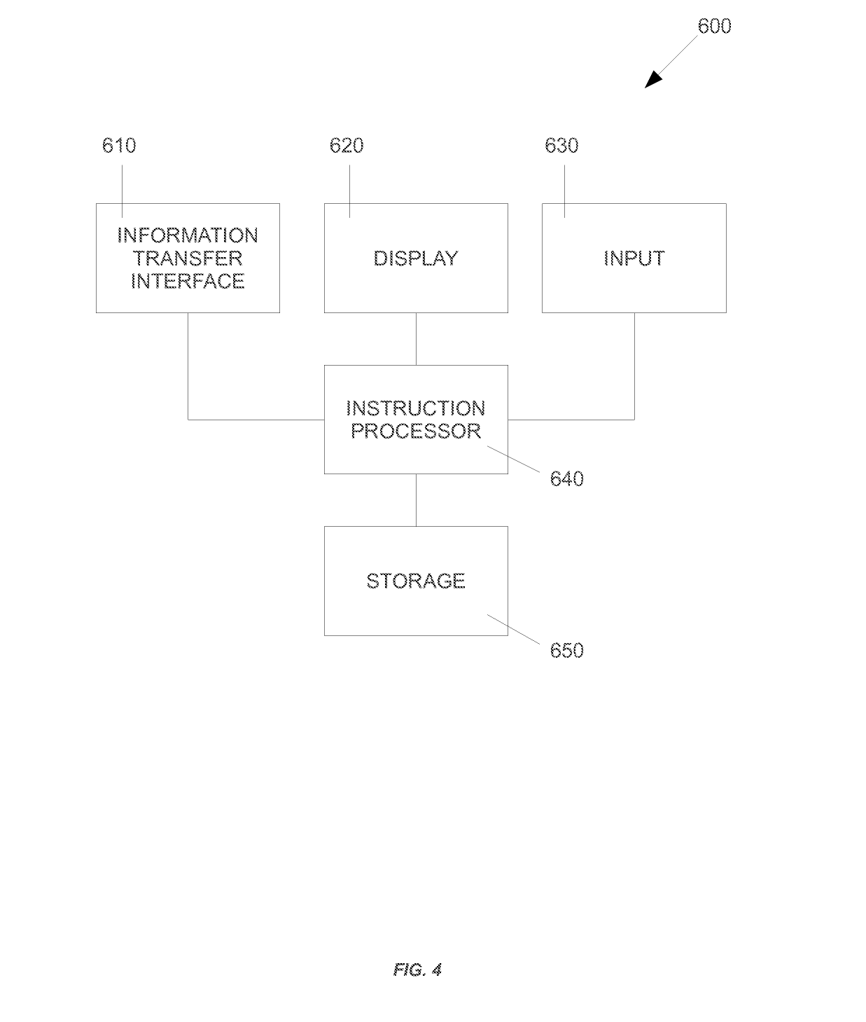

FIG. 4 illustrates a Content Provider Device 600 comprised of an Information Transfer Interface 610, Display 620, Input peripheral 630, Instruction Processor 640, and Storage 650 device. Content Provider Devices 600 are connected to an Information Transfer Medium 300 that can send Rebate Marketing Promotion information to the Assistant System 200, Content Provider Devices 600 have Display 620, Input peripheral 630, and Instruction Processor 640 devices that allow the Assistant System 200 to receive Rebate Marketing Promotion information. Content Provider Devices 600 store Rebate Marketing Promotion information on Storage 650 device.

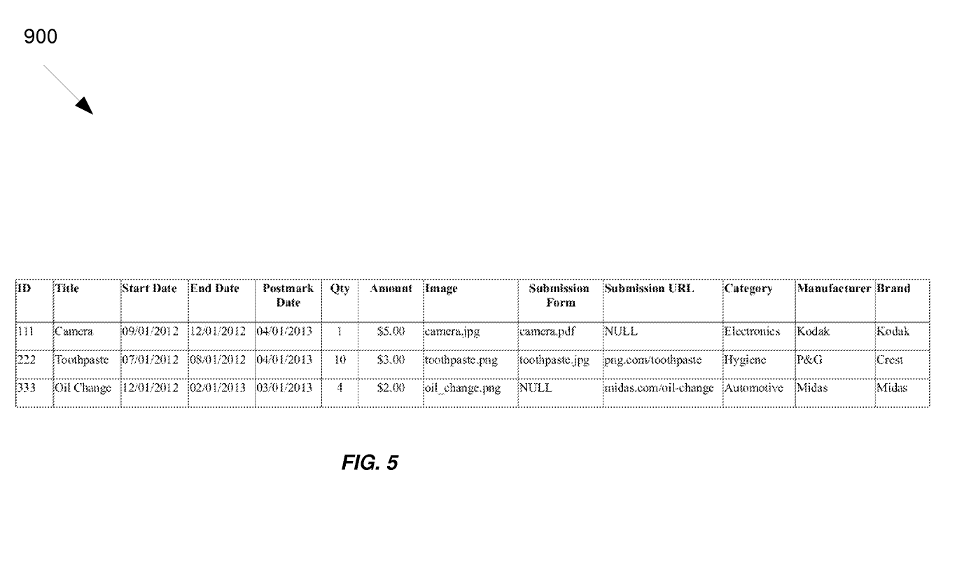

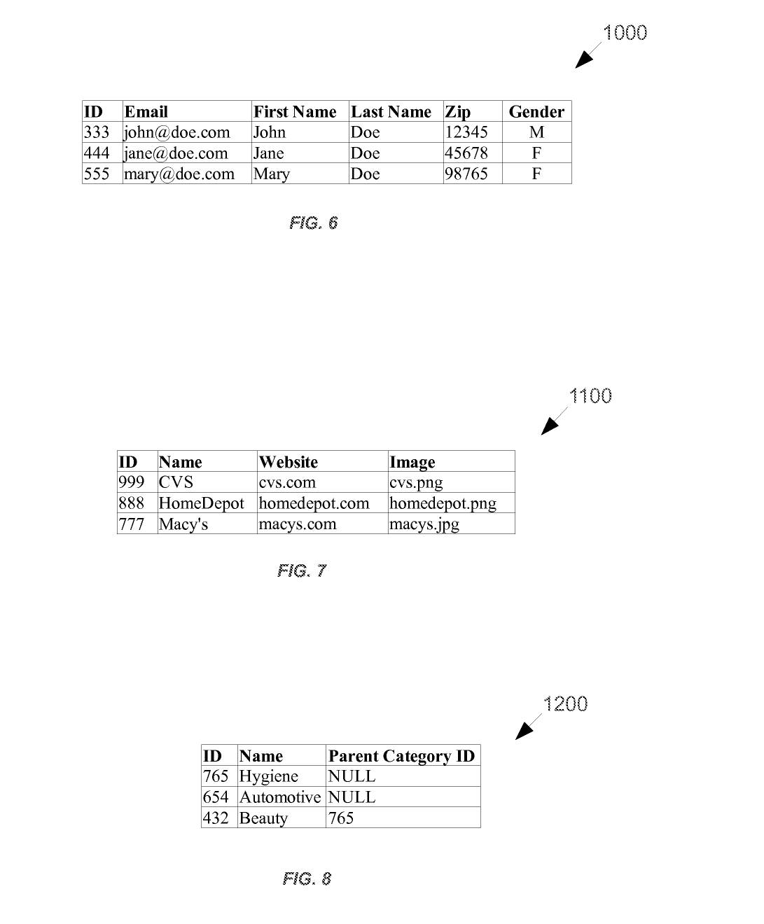

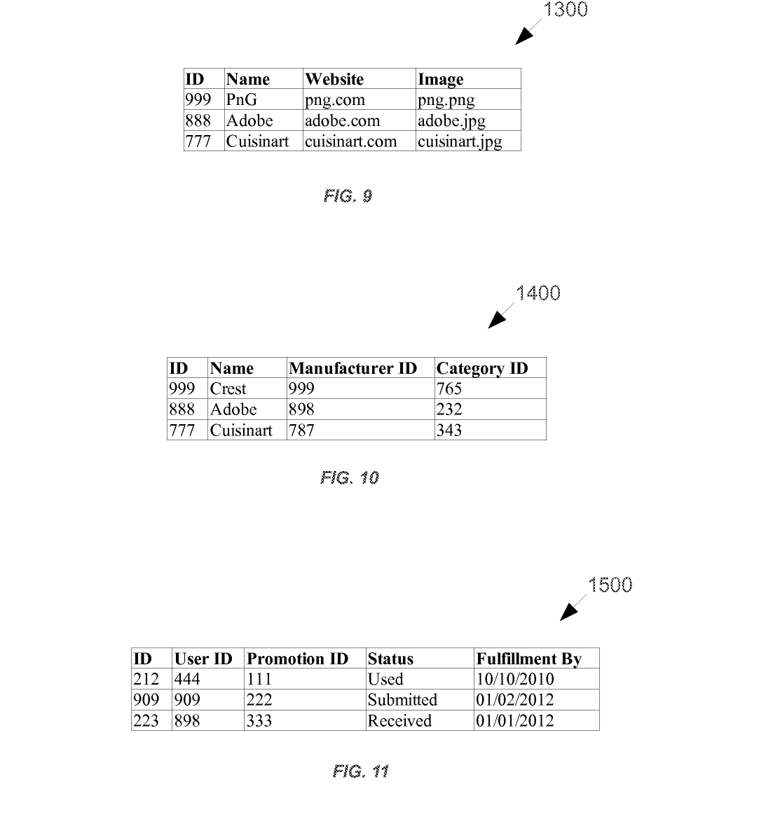

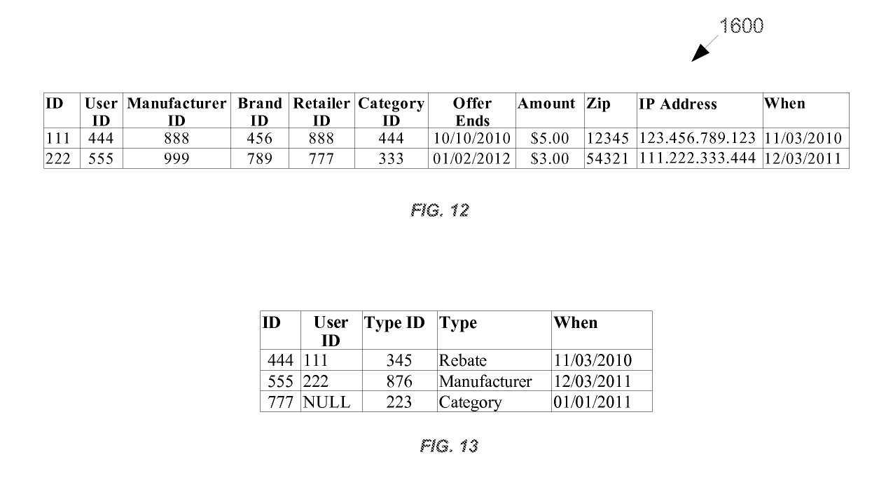

FIGS. 5 through 13 illustrate Assistant System 200 Storage 250 device structures for a Promotion Database 900, Consumer Database 1000, Retailer Database 1100, Category Database 1200, Manufacture Database 1300, Brand Database 1400, Tracking Database 1500, and Statistics Database 1600, which contains Rebate Marketing Promotion information that allows the Assistant System 200 to associate, present, layout, arrange, store, track, categorize, organize, store, and process statistical and associated and related information sent to and from Consumer Devices 400 and Content Provider Devices 600.

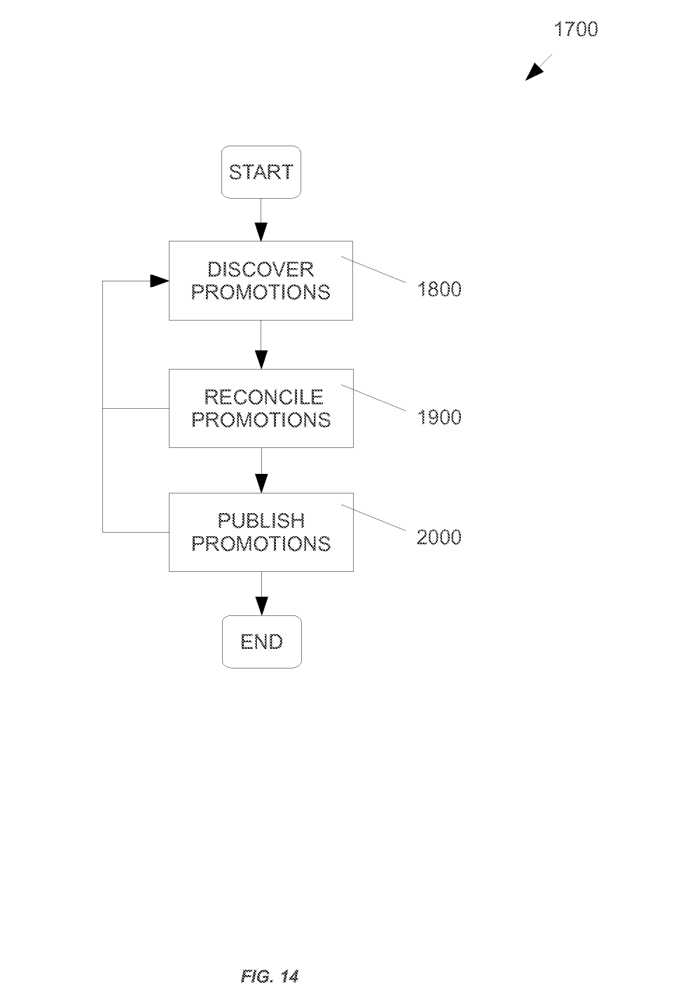

FIG. 14 illustrates Rebate Marketing Promotion Publishing method 1700 stored by Assistant System 200 Storage 250 device and processed by Instruction Processor 240. Discover Promotions 1800 uses Assistant System 200 Information Transfer Interface 210 and Instruction Processor 240 to read and process new and updated Rebate Marketing Promotion information from Content Provider Devices 600 Information Transfer Interface 610 device and persists discovered Rebate Marketing Promotion information for future processing using Assistant System 200 Storage 250 device. Reconcile Promotions 1900 method uses Assistant System 200 Storage 250 device and Instruction Processor 240 to package Rebate Marketing Promotion information for addition, augmentation, and removal of discovered Rebate Marketing Promotion information by Assistant System 200 operator using Assistant System 200 Display 200, Input 230 peripheral, Information Transfer Interface 210, and Storage 250 device and uses Assistant System 200 Instruction Processor 240, Display 200, Input 230 peripheral, Information Transfer Interface 210, and Storage 250 device to unpack and persist reconciled Rebate Marketing Promotion information for future processing. Publish Promotions 2000 method uses Assistant System 200 Storage 250 device and Instruction Processor 240 to archive previous versions of updated Rebate Marketing Promotion information and publish new and updated Rebate Marketing Promotion information providing Rebate Marketing Promotion information available to Consumer Devices 400 Information Transfer Interlace 410 and Content Provider Devices 600 Information Transfer Interface 610 by writing Rebate Marketing Promotion information to Assistant System 200 Information Transfer Interface 210.

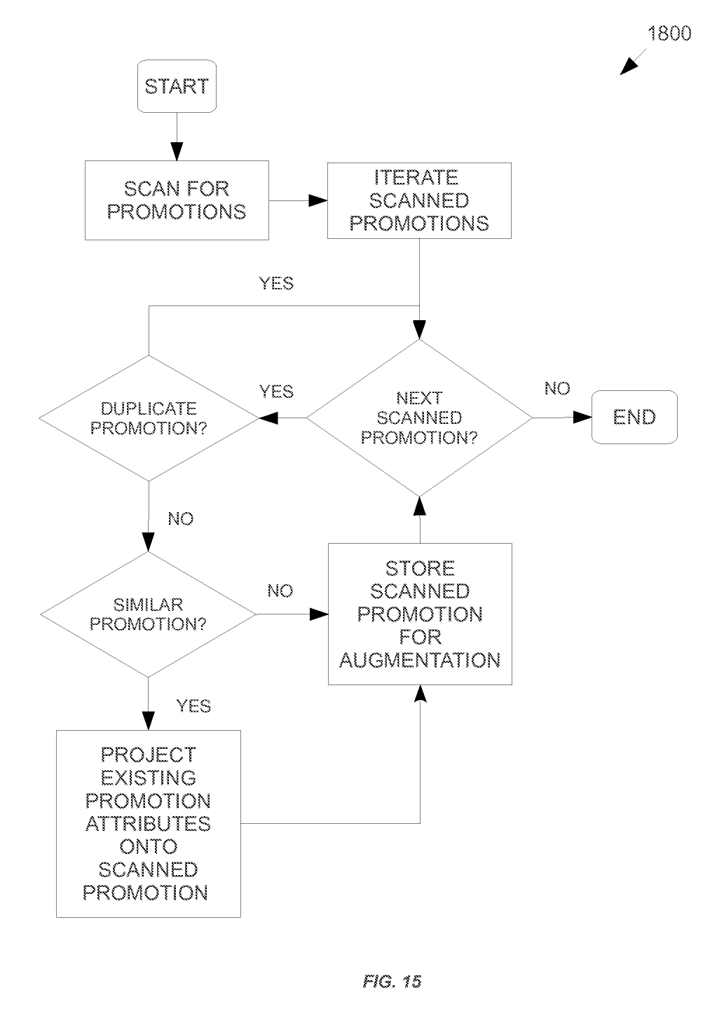

FIG. 15 illustrates Discover Promotions 1800 method stored by Assistant System 200 Storage 250 device and processed by Instruction Processor 240. Discover Promotions 1800 method uses Assistant System 200 Information Transfer Interface 210 to connect and read (scan) Rebate Marketing Promotion information from Content Provider Devices 600 Information Transfer interface 610 temporarily storing scanned Rebate Marketing Promotion information in Assistant System 200 Storage 250 device. Discover Promotions 1800 method iterates over temporarily scanned Rebate Marketing Promotion information using Assistant System 200 Instruction Processor 240 to compare existing Rebate Marketing Promotion information stored in Promotion Database 900 skipping future processing of temporarily stored Rebate Marketing Promotion information given an exact match. Otherwise, Discover Promotions 1800 method uses Assistant System 200 Instruction Processor 240 to compare the similarities of scanned Rebate Marketing Promotion information to existing Rebate Marketing, Promotions information stored in Promotion Database 900 resulting in either temporary storage of unaltered scanned Rebate Marketing Promotion information in Storage 250 device or, given existing Rebate Marketing Promotion information was found to be similar to scanned Rebate Marketing Promotion information, Instruction Processor 240 uses existing Rebate Marketing Promotion information stored in Storage 250 device to supplement scanned Rebate Marketing Promotion information and temporarily storing results in Storage 250 device for further processing.

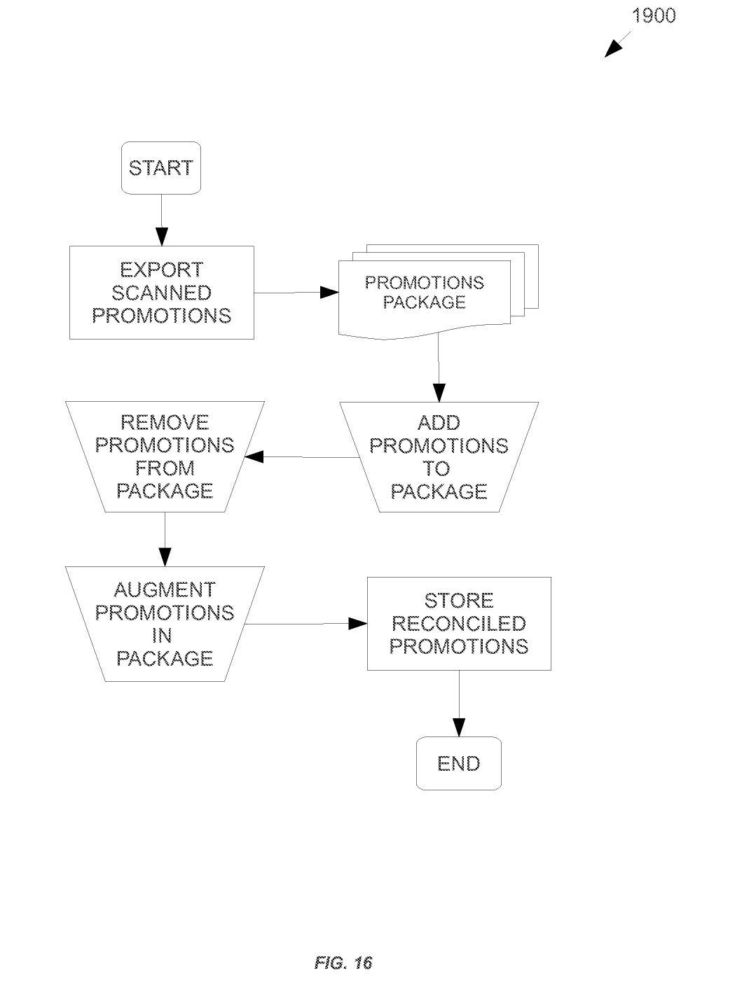

FIG. 16 illustrates Reconcile Promotion 1900 method stored by Assistant System 200 Storage 250 device and processed by Instruction Processor 240, Reconcile Promotion 1900 method uses Assistant System 200 Information Transfer Interface 210, Display 220 device, Input 230 peripherals, Instruction Processor 240, and Storage 250 device to allow an Assistant System 200 operator to export (download) a promotion package representing the contents of temporarily stored Rebate Marketing Promotion information in Storage 250 device Promotions Database 900 and associated Rebate Marketing Promotion information; for example, redemption forms, questionnaires, and graphics, and so on. Given an exported promotion package an Assistant System 200 operator has the opportunity to add, remove, and augment Rebate Marketing Promotion information to the exported package and import (upload) using Assistant System 200 Information Transfer Interface 210, Display 220 device, Input 230 peripherals, and Instruction Processor 240 temporarily storing results in Storage 250 device for further processing.

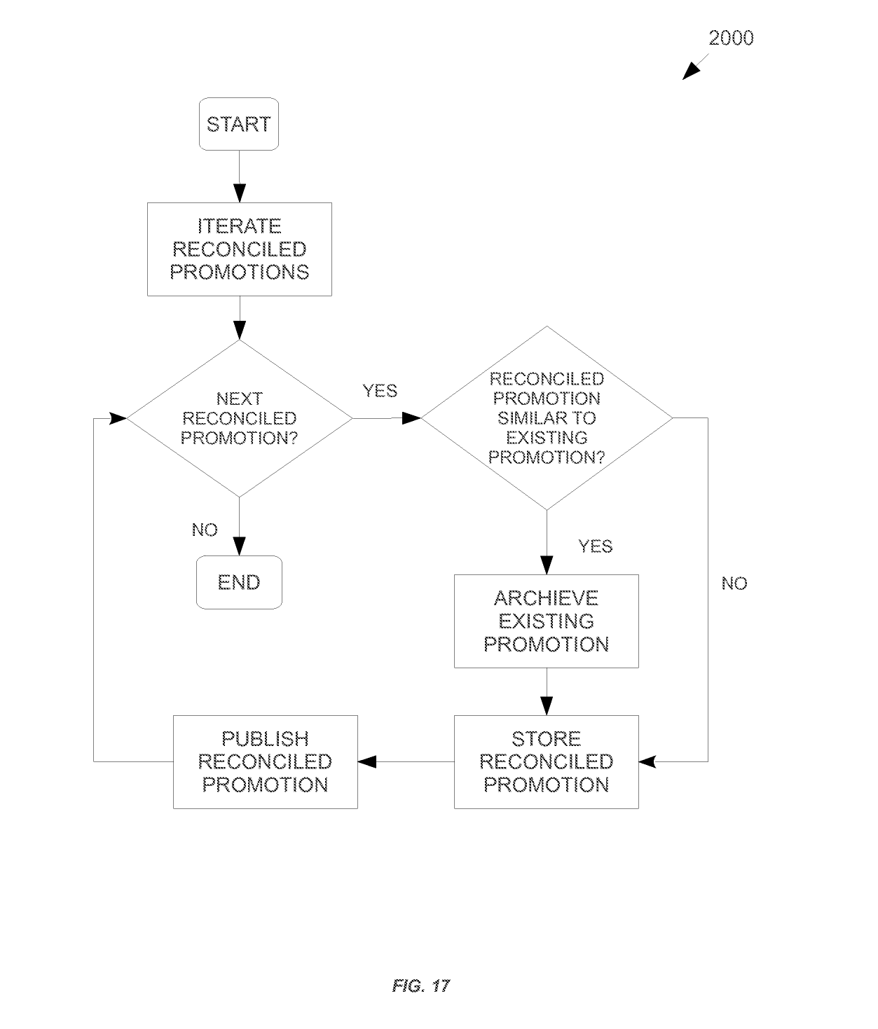

FIG. 17 illustrates Publish Promotions 2000 method stored by Assistant System 200 Storage 250 device and processed by instruction Processor 240. Publish Promotions 2000 method uses Assistant System 200 Instruction Processor 240 and Storage 250 device to unpack, parse, and iterate reconciled promotion information to compare the reconciled promotion information to existing Rebate Marketing Promotion information stored in Storage 250 device and either, archive existing Rebate Marketing Promotion information stored in Storage 250 device, given a comparison is a match, or directly store reconciled promotion information in Storage 250 device Promotions Database 900, Retailer Database 1100, Category Database 1200, Manufacturer Database 1300, and Brand Database 1400, thereby publishing Rebate Marketing Promotion information. Published Rebate Marketing Promotion information is made available to Consumer Devices 400 and Content Provider Devices 600 by reading from Assistant System 200 Information Transfer Interface 210.

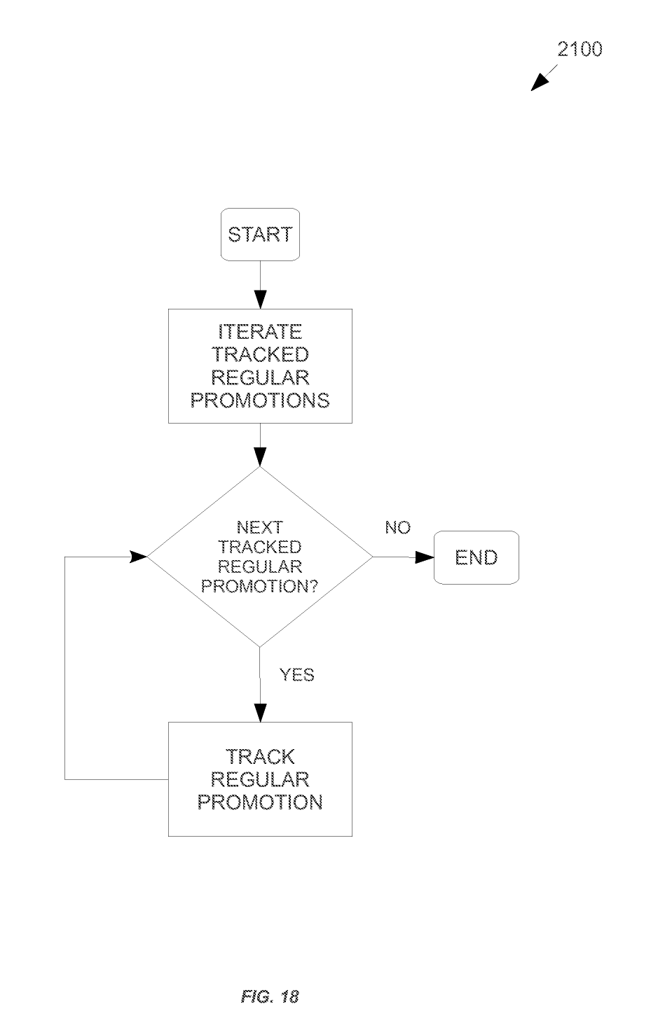

FIG. 18 illustrates iterate Tracked Regular Promotions 2100 method stored by Assistant System 200 Storage 250 device and processed by Instruction Processor 240. Iterate Tracked Regular Promotions method reads Rebate Marketing Promotion stored in Assistant System 200 Storage 250 device Promotion Database 900 and for each read Rebate Marketing Promotion uses Instruction Processor 240 to perform Track Regular Promotions 2200 method stored in Storage 250 device.

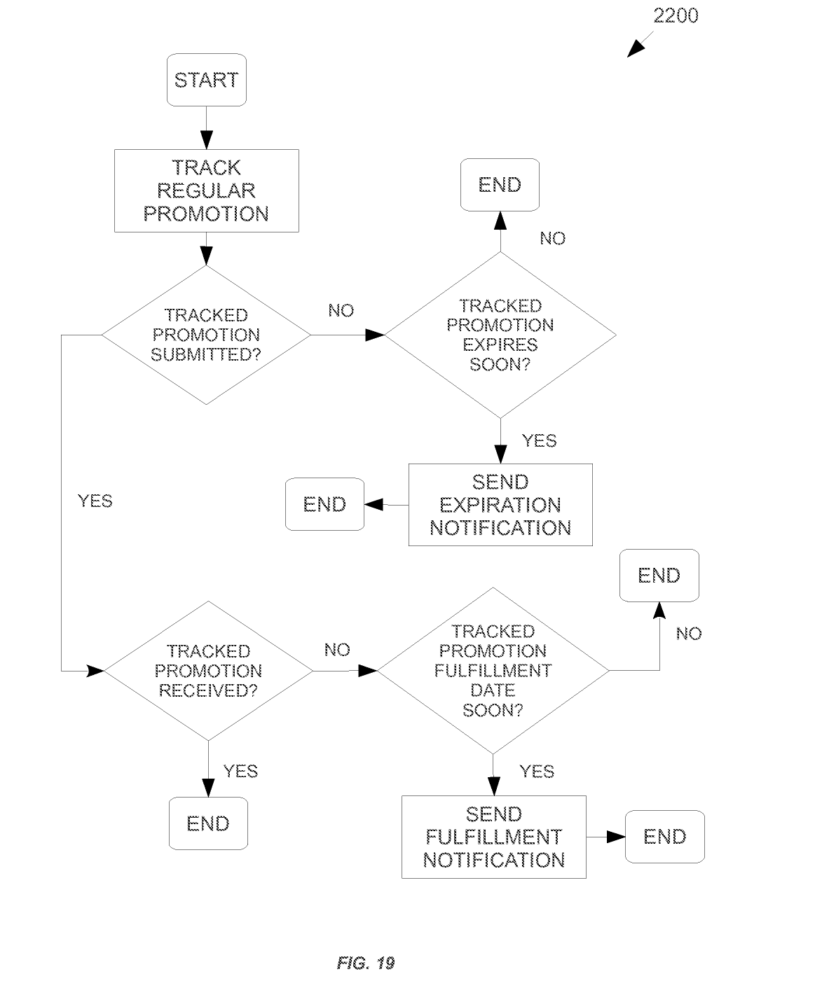

FIG. 19 illustrates Track Regular Promotions 2200 method stored by Assistant System 200 Storage 250 device and processed by Instruction Processor 240, Assistant System 200 allows Consumer Devices 400 Information Transfer Interface 410 to read Rebate Marketing Promotion information from Assistant System 200 Storage 250 device Promotion Database 900 using Information Transfer Interface 210 to display read Rebate Marketing Promotion information on Consumer Devices 400 Display 440 using Consumer Devices 400 Instruction Processor 410. Assistant System 200 allows Consumer Devices 400 to track regular Rebate Marketing Promotions through a predefined industry standard Rebate Marketing Promotion lifecycle by writing a predefined command to Consumer Devices 400 Information Transfer Interface 410 read by Assistant System 200 Information Transfer Interface 210, triggering verification of Consumer Devices 400 identity using Assistant System 200 instruction Processor 240 and Storage 250 device Consumer Database 1000, verification of Rebate Marketing Promotion information from command previously read and parsed command using Assistant System 200 Instruction Processor 240 and Storage 250 device Promotion Database 900, resulting in the storage of tracked Regular Rebate Marketing Promotion and associated verified Consumer in Storage 250 device Tracking Database 1500. Track Regular Promotions 2200 method iterates tracked Regular Rebate Marketing Promotions using Assistant System 200 Instruction Processor 240 and Storage 250 device Promotion Database 900 comparing and determining the corresponding Rebate Marketing Promotion lifecycle phase and triggering an associated action needed to alert, or notify, the Consumer using Consumer Devices 400 by writing a command to Assistant System 200 Information Transfer interface 210 read by Consumer Devices 400 Information Transfer Interface 410 and displayed by Consumer Devices 400 Display 420. Track Regular Promotions 2200 method determines if the tracked Regular Rebate Marketing Promotion has been submitted by Consumer using Consumer Devices 400 Information Transfer Interface 410 to write a command to Assistant System 200 Information Transfer Interface 420, processed by Assistant System 200 instruction Processor 220, and stored in Storage 250 device Tracking Database 1500. Given the tracked Regular Rebate Marketing Promotion has not been submitted Track Regular Promotions 2200 method determines if the tracked Regular Rebate Marketing Promotion is soon to expire using Assistant System 200 Instruction Processor 240. Given the tracked Regular Rebate Marketing Promotion is not soon to expire no action is taken by Track Regular Promotions 2200 method. Given the Regular Rebate Marketing Promotion is soon to expire Track Regular Promotions 2200 method uses Assistant System 200 Information Transfer Interface 210 to write a command to Consumer Devices 400 Information Transfer Interface 420 alerting, or notifying, Consumer, using Consumer Devices 400 Display 420, of nearing Regular Rebate Marketing Promotion expiration. Given the tracked Regular Rebate Marketing Promotion has been submitted Track Regular Promotions 2200 method determines if the tracked Regular Rebate Marketing Promotion has been received by Consumer using Consumer Devices 400 Information Transfer interface 410 to write a command to Assistant System 200 Information Transfer Interface 220, processed by Instruction Processor 240, and stored in Storage 250 device Tracking Database 1500. Given the tracked Regular Rebate Marketing Promotion has been received no action is taken by Track Regular Promotions 2200 method. Given the tracked Regular Rebate Marketing Promotion has not been received Track Regular Promotions 2200 method determines if the tracked Regular Rebate Marketing Promotion fulfillment date is nearing using Assistant System 200 Instruction Processor 240. Given the tracked Regular Rebate Marketing Promotion fulfillment date is not near no action is taken by Track Regular Promotions 2200 method. Given the tracked Regular Rebate Marketing Promotion fulfillment date is near Track Regular Promotions 2200 method uses Assistant System 200 Information Transfer Interface 210 to write a command to Consumer Devices 400 Information Transfer Interface 420 alerting, or notifying, Consumer, using Consumer Devices 400 Display 420, of nearing Regular Rebate Marketing Promotion fulfillment date.

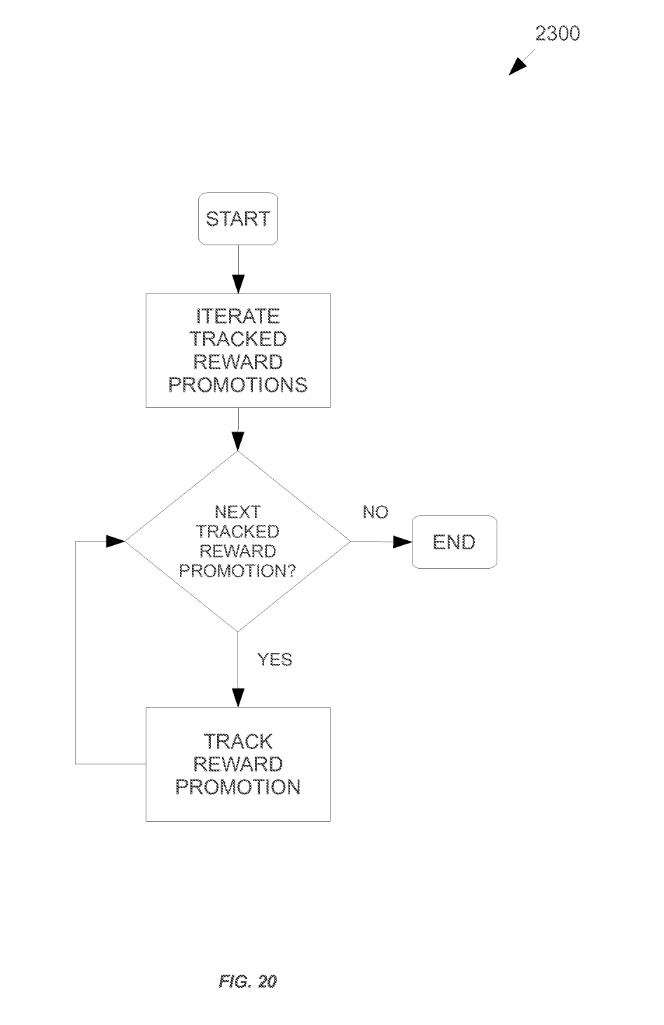

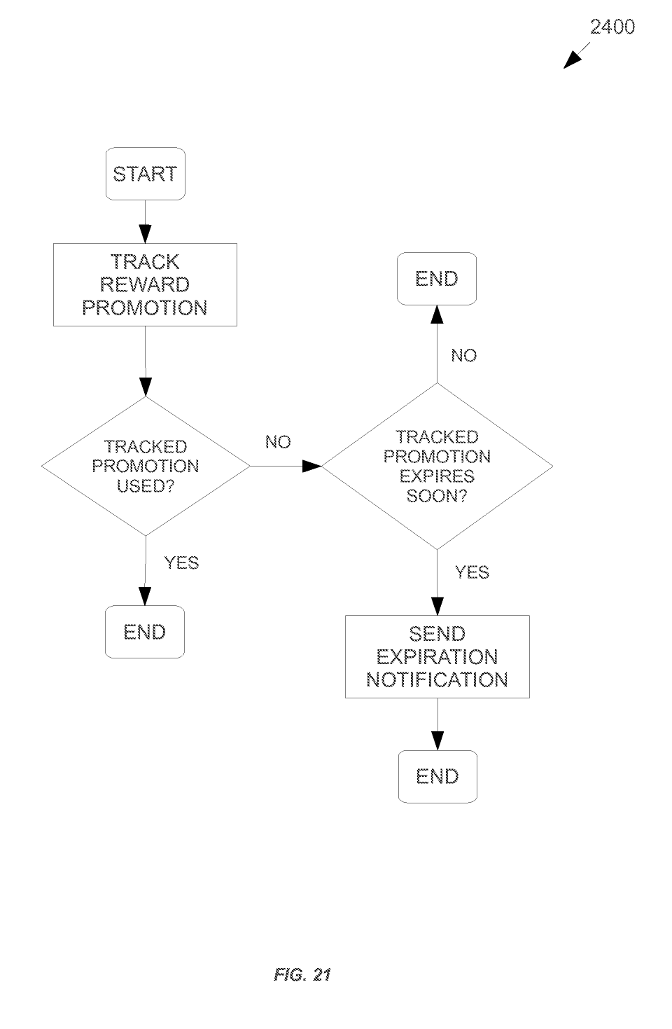

FIG. 20 illustrates Iterate Tracked Reward Promotions 2300 method stored by Assistant System 200 Storage 250 device and processed by instruction Processor 240, Iterate Tracked Reward Promotions 2300 method reads Rebate Marketing Promotion stored in Storage 250 device Promotion Database 900 and for each read Rebate Marketing Promotion uses Instruction Processor 2411 to perform Track Reward Promotions 2400 method stored in Storage 250 device.

FIG. 21 illustrates Track Reward Promotions 2400 method stored by Assistant System 200 Storage 250 device and processed by instruction Processor 240, Assistant System 200 allows Consumer Devices 400 Information Transfer Interface 410 to read Rebate Marketing Promotion information from Assistant System 200 Storage 250 device Promotion Database 900 using Information Transfer Interface 210 to display read Rebate Marketing Promotion information on Consumer Devices 400 Display 440 using Consumer Devices 400 Instruction Processor 410. Assistant System 200 allows Consumer Devices 400 to track reward Rebate Marketing Promotions through a predefined industry standard Rebate Marketing Promotion lifecycle by writing a command to Consumer Devices 400 information Transfer Interface 410 read by Assistant System 200 Information Transfer Interface 210, triggering verification of Consumer Devices 400 identity using instruction Processor 240 and Storage 250 device Consumer Database 1000, verification of Rebate Marketing Promotion information from command previously read and parsed command using Instruction Processor 240 and Storage 250 device Promotion Database 900, resulting in the storage of tracked Reward Rebate Marketing Promotion and associated verified Consumer in Storage 250 device Tracking Database 1500. Track Reward Promotions 2200 method iterates tracked Reward Rebate Marketing Promotions using Instruction Processor 240 and Storage 250 device Promotion Database 900 comparing and determining the corresponding Rebate Marketing Promotion lifecycle phase and triggering an associated action needed to alert, or notify, the Consumer using Consumer Devices 400 by writing a command to Assistant System 200 Information Transfer Interface 210 read by Consumer Devices 400 information Transfer Interface 410 and displayed by Consumer Devices 400 Display 420. Track Reward Promotions 2400 method determines if the tracked Reward Rebate. Marketing Promotion has been used by Consumer using Consumer Devices 400 Information Transfer Interface 410 to write a command to Assistant System 200 Information Transfer Interface 420, processed by Instruction Processor 420, and stored in Storage 250 device Tracking Database 1500. Given the tracked Reward Rebate Marketing Promotion has been used the no action is taken by Track Reward Promotions 2400 method. Given the tracked Reward Rebate Marketing Promotion has not been used Track Reward Promotions 2400 method uses Instruction Processor 240 to determine if the tracked Reward Rebate Marketing Promotion is soon to expire. Given the tracked Reward Rebate Marketing Promotion is not soon to expire no action is taken by Track Reward Promotions 2400. Given the tracked Reward Rebate Marketing Promotion is soon to expire Track Reward Promotions 2400 method uses Assistant System 200 Information Transfer Interface 210 to write a command to Consumer Devices 400 Information Transfer Interface 420 alerting, or notifying, Consumer, using Consumer Devices 400 Display 420, of nearing Reward Rebate Marketing Promotion expiration date.

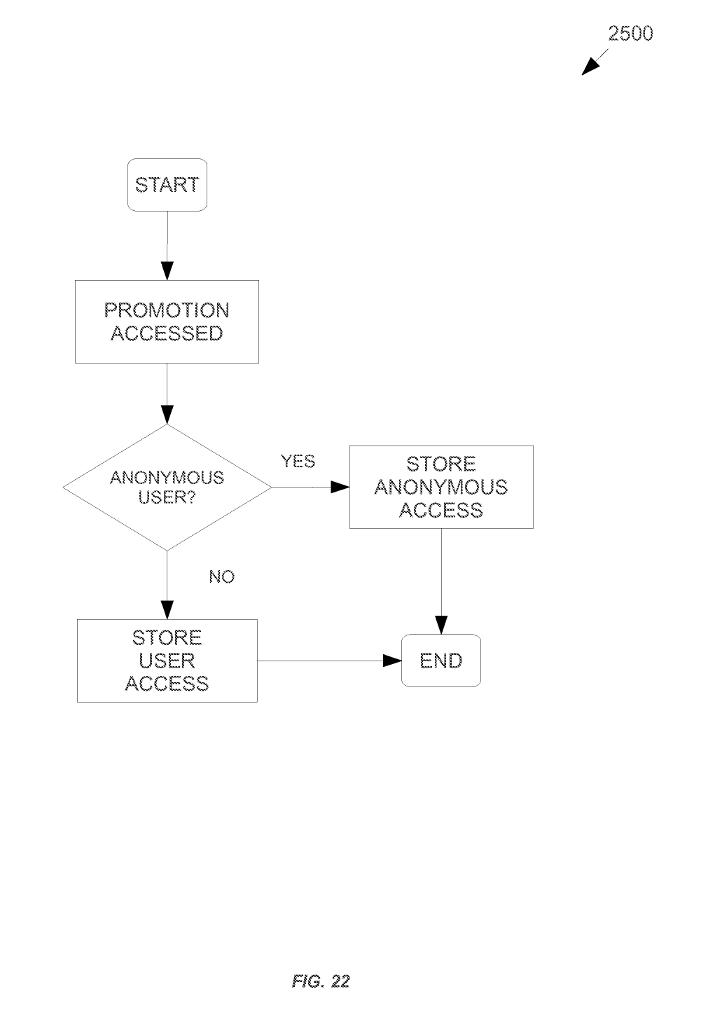

FIG. 22 illustrates Rebate Marketing Promotion Interest 2500 method stored by Assistant System 200 Storage 250 device and processed by Instruction Processor 240. Interest 2500 method allows Consumer Devices 400 Information Transfer Interface 410 and Content Provider Devices 6110 Information Transfer Device 610 to read Rebate Marketing Promotion information from Assistant System 200 Storage 250 device Promotion Database 900 using Information Transfer Interface 210 to display read Rebate Marketing Promotion information on Consumer Devices 400 Display 440 using Consumer Devices 400 instruction Processor 410 and Content Provider Devices 600 using Content Provider Devices 600 Instruction Process or 610 and Display 640. Interest 2509 method stores using Assistant System 200 Storage 250 device Statistics Database 1600 and Instruction Processor 240, interests in Rebate Marketing Promotion information when Consumer Devices 400 information Transfer interface 410 and Content Provider Devices 600 Information Transfer Interface 610 reads Rebate Marketing Promotion information from Assistant System 200 Storage 250 device Promotion Database 900 using Information Transfer Interface 210. Interest 2500 method allows Rebate Marketing Promotion information statistics to be calculated using Assistant System 200 Storage 250 device and Instruction Processor 240 and the results read by Consumer Devices 400 Information Transfer interface 410 and Content Provider Devices 600 Information Transfer Interface 610 using Assistant System 200 Information Transfer Interface 210 and displayed on Consumer Devices 400 Display 420 and Content Provider Devices 600 Display 620.

### CONCLUSIONS, RAMIFICATIONS, AND SCOPE

Accordingly, it has been shown that the Rebate Marketing Promotion Assistant provides a central resource to discover, collect, store, augment, and organize Rebate Marketing Promotion information in a database for consumers, organizations, and third-parties to access. Additionally, the Rebate Marketing Promotion Assistant provides a central resource for consumers, organizations, and third-parties to track, monitor, and receive notifications of predefined industry standard Rebate Marketing Promotion lifecycle events, receive notifications of changes to the Rebate Marketing Promotion Assistant database, and tools to analyze aspects of database usage.

As a result, Rebate Marketing Promotion Assistant substantially assists consumers, organizations, and third-parties in Rebate Marketing Promotion utilization, which capitalizes on Rebate Marketing Promotion information intelligence.

The description above should not be construed as limiting the scope of the embodiments. The scope of the embodiments should be determined by the appended claims and their legal equivalents, rather than by the examples given.

What is claimed is:

1. A computer readable storage device storing a computer program that, when executed by a computer system, causes said computer system to perform a method comprising:
discovering new and updated rebate marketing promotion information, wherein the discovery comprises:
scanning rebate marketing promotion information, by said computer system via a information transfer interface, from a plurality of rebate marketing promotion content provider devices
projecting of existing rebate marketing promotion information, stored on said computer readable storage device, onto scanned rebate marketing promotion information
storing result of said scanning of new rebate marketing promotion information and said projection of existing rebate marketing promotion information on said computer readable storage device
reconciling said scanned rebate marketing promotion information, wherein the reconciliation comprises:
exporting said scanned rebate marketing promotion information, stored on said computer readable storage device, transferable via said information transfer interface
augmentation of said exported rebate marketing promotion information by a user of said computer system
storing of said augmented rebate marketing promotion information to said computer readable storage device
publishing said augmented rebate marketing promotion information, wherein the publishing comprises:
archiving of said existing rebate marketing promotion information similar to said augmented rebate marketing promotion information, stored on said computer readable storage device, comparing a plurality of attributes of said augmented rebate marketing promotion information to a plurality of attributes of said existing rebate marketing promotion information
posting of said augmented rebate marketing promotion information storing results on said computer readable storage device transferable via said information transfer interface
tracking said published rebate marketing promotion information, wherein the tracking comprises:
associating a user of said computer system to said published rebate marketing promotion information
determining, by said association state, if a notification should be sent to said user of said computer system
sending, using said association, said notification of said association state
calculating statistics of rebate marketing promotion information, wherein the calculation comprises:
associating, said user of said computer system to said rebate marketing promotion information
storing, interest activity of rebate marketing promotion information to said computer readable storage device
calculating, statistical information of said interest activity sending, said calculations to a plurality of predetermined users of said computer system

2. The method of claim 1, further comprising: said scanning scans a plurality of web pages, via said information transfer interface, over the world wide web

3. The method of claim 1, further comprising: said scanning scans a plurality of web endpoint interfaces of said plurality of rebate marketing promotion content provider devices, via said information transfer interface, over the world wide web

4. The method of claim 1, further comprising: said projection copies missing information of said existing rebate marketing promotion information onto scanned rebate marketing promotion information

5. The method of claim 1, further comprising: said export of rebate marketing promotion information into a transferable package assembled by said computer system processor

6. The method of claim 1, further comprising: means of said augmentation of rebate marketing promotion information is provided by a plurality of web pages available via said information transfer interface of said computer system to a plurality of predefined said computer system users

7. The method of claim 1, further comprising: means of said storage of said augmented rebate marketing promotion information is provided by a plurality of web pages available via said information transfer interface of said computer system to a plurality of predefined said computer system users

8. The method of claim 1, further comprising: said archiving of said existing rebate marketing promotion information uses at least the rebate marketing promotion title attribute

9. The method of claim 1, further comprising: means of said posting of said augmented rebate marketing promotion information is provided by a plurality of web pages, available to a plurality of users of said computer system via said information transfer interface

10. The method of claim 1, further comprising: means of said posting of said augmented rebate marketing promotion information is provided by a plurality of web endpoints, available to a plurality of users of said computer system via said information transfer interface

11. The method of claim 1, further comprising: said association of said user of said computer system to said published rebate marketing promotion information further including at least a user identifier and a published rebate marketing promotion information identifier

12. The method of claim 1, further comprising: said association of said user of said computer system to said published rebate marketing promotion information further including at least a plurality of manufacturer identifier, brand identifier, category identifier, and retailer identifier attributes

13. The method of claim 1, further comprising: determination of said notification further including at least a plurality of rebate marketing promotion information start date, end date, postmark date, status, and fulfillment by attributes

14. The method of claim 1, further comprising: said notification state further includes at least a plurality of manufacturer title, brand title, category title, retailer tide, rebate marketing promotion title, rebate marketing promotion quantity, rebate marketing promotion amount, rebate marketing promotion start date, rebate marketing promotion end date, rebate marketing promotion postmark date, rebate marketing promotion status, and rebate marketing promotion fulfillment by attributes

15. The method of claim 1, further comprising: said notification is sent by at least email and SMS via said information transfer interface of said computer system

16. The method of claim 1, further comprising: said association of said user of said computer system to said rebate marketing promotion information further including at least an internet protocol address and at least a plurality of manufacturer identifier, brand identifier, category identifier, retailer identifier, and rebate marketing promotion identifier

17. The method of claim 1, further comprising: said storage of said interest activity of rebate marketing promotion information further including at least an internet protocol address of said associated user, date of said interest activity, and at least a plurality of manufacturer identifier, brand identifier, category identifier, retailer identifier, and rebate marketing promotion identifier of said rebate marketing promotion information

18. The method of claim 1, further comprising: said calculation of said statistical information further including at least a plurality of internet protocol addresses of said associated users and at least a plurality of manufacturer titles, brand titles, category titles, retailer titles, and rebate marketing promotion titles of said rebate marketing promotion information

19. The method of claim 1, further comprising: said sending of said calculations to a plurality of predetermined users of said computer system, via said information transfer interface, over the world wide web
whereby the results substantially assist consumers, producers, and thirdparties in rebate marketing promotion utilization.
